(19) United States
(12) Patent Application Publication
(10) Pub. No.: US 2025/0037984 A1
(43) Pub. Date: Jan. 30, 2025

(54) MASS SPECTROMETER AND CONTROL METHOD THEREFOR

(71) Applicant: SHIMADZU CORPORATION, Kyoto (JP)

(72) Inventors: Ryo FUJITA, Kyoto (JP); Tomoyoshi MATSUSHITA, Kyoto (JP)

(73) Assignee: SHIMADZU CORPORATION, Kyoto (JP)

(21) Appl. No.: 18/709,488

(22) PCT Filed: Aug. 26, 2022
(86) PCT No.: PCT/JP2022/032134

§ 371 Date: May 11, 2024

(30) Foreign Application Priority Data
Nov. 16, 2021 (JP) 2021-186359

(51) Int. Cl. H01J 49/10; H01J 49/24; H01J 49/42

(52) U.S. Cl. CPC H01J 49/105; H01J 49/24; H01J 49/4215

(57) ABSTRACT

When a gas is supplied from a gas supply unit (19) to a collision cell (11) in detection of a first target ion, before detection of the first target ion, a controller (22) applies a voltage having a first adjustment voltage value to an electrode located on a downstream side of the collision cell (11) in an ion traveling direction, the first adjustment voltage value being obtained by adding an adjustment value to a first detection voltage value corresponding to the first target ion, and in detection of the first target ion, the controller (22) applies a voltage having the first detection voltage value to the electrode located on the downstream side of the collision cell (11) in the ion traveling direction. The adjustment value is a value indicating a polarity opposite to a polarity of the first target ion.

### TECHNICAL FIELD

The present invention relates to an inductively coupled plasma (ICP) mass spectrometer.

### BACKGROUND ART

An ICP mass spectrometer ionizes, by plasma, an element to be detected, which is included in a liquid sample, and detects resultant ions using a detector (refer to, for example, Japanese Patent Laying-Open No. 10-241625 (PTL 1)).

### CITATION LIST

### Patent Literature

PTL 1: Japanese Patent Laying-Open No. 10-241625

### SUMMARY OF INVENTION

### Technical Problem

In an ICP mass spectrometer, ions pulled into a vacuum are taken into a chamber maintained in a vacuum atmosphere. The taken ions are accelerated by an electric field formed by a pull-out electrode, and are introduced into a collision cell through a converging lens. In addition to ions of a component (element) to be observed, interference ions generated due to various factors are also introduced into the chamber. The interference ions include ions caused by a gas such as argon used to generate plasma in an ICP ion source, ions caused by a foreign matter included in a liquid sample or an additive (such as nitric acid or hydrochloric acid) added to a liquid sample, and the like. In order to separate the interference ions and the target ions, the collision cell is provided in the ICP mass spectrometer.

During analysis, a gas (a collision gas such as an inert gas, or a reaction gas such as hydrogen or ammonia) is introduced into the collision cell in some cases. Various ions introduced into the collision cell repeatedly come into contact with the gas in the collision cell. Every time the ions come into contact with the gas, the kinetic energy of the ions decreases. Generally, the interference ions are polyatomic ions and are larger in collision cross-sectional area than the ions of the element to be observed that has the same mass. Therefore, the number of times of contact between the interference ions and the gas is larger than the number of times of contact between the ions of the element to be observed and the gas, and thus, the kinetic energy of the interference ions is smaller than the kinetic energy of the ions of the component to be observed in the collision cell.

A potential barrier is formed at an exit of the collision cell so as to allow only ions having the kinetic energy of a prescribed value or more to pass therethrough and to block ions having the kinetic energy of less than the prescribed value. Thus, the interference ions are separated from the ions of the component to the observed, and are removed.

During analysis, the gas is not introduced into the collision cell in some cases. In such a case, removal of the interference ions by contact with the gas cannot be expected. Thus, the interference ions reach a mass filter, which results in charge up of an electrode that forms the mass filter.

Specifically, in the ICP mass spectrometer, a larger amount of the interference ions are introduced into the mass filter when the gas is not introduced into the collision cell during analysis than when the gas is introduced into the collision cell. Thus, charge up of the electrode that forms the mass filter is greater when the gas is not introduced into the collision cell than when the gas is introduced into the collision cell. This causes a great difference in analysis conditions between when the gas is not introduced into the collision cell and when the gas is introduced into the collision cell.

The present invention has been made in light of the above-described circumstances, and an object thereof is to provide the technique for reducing a difference in analysis conditions between when a gas is not introduced into a collision cell during analysis in an ICP mass spectrometer and when the gas is introduced into the collision cell.

### Solution to Problem

A mass spectrometer according to an aspect of the present disclosure includes: a plasma ion source that ionizes a sample by a plasma ion; a mass filter that allows a target ion having a specific mass-to-charge ratio, of the ionized sample, to selectively pass therethrough; a detector that detects the target ion; a collision cell provided between the plasma ion source and the mass filter; a gas supply unit that supplies a gas to the collision cell; and a controller that controls a value of a voltage applied to an electrode, wherein when the gas is supplied from the gas supply unit to the collision cell in detection of a first target ion, before detection of the first target ion, the controller applies a voltage having a first adjustment voltage value to an electrode located on a downstream side of the collision cell in an ion traveling direction, the first adjustment voltage value being obtained by adding an adjustment value to a first detection voltage value corresponding to the first target ion, and in detection of the first target ion, the controller applies a voltage having the first detection voltage value to the electrode located on the downstream side of the collision cell in the ion traveling direction, and the adjustment value is a value indicating a polarity opposite to a polarity of the first target ion.

In a control method for a mass spectrometer according to an aspect of the present disclosure, the mass spectrometer includes: a plasma ion source that ionizes a sample by a plasma ion; a mass filter that allows a target ion having a specific mass-to-charge ratio, of the ionized sample, to selectively pass therethrough; a detector that detects the target ion; and a collision cell provided between the plasma ion source and the mass filter. The control method for the mass spectrometer includes: determining whether to supply a gas to the collision cell in detection of a first target ion; when it is determined to supply the gas to the collision cell in detection of the first target ion, before detection of the first target ion, applying a voltage having a first adjustment voltage value to an electrode located on a downstream side of the collision cell in an ion traveling direction in the mass spectrometer, the first adjustment voltage value being obtained by adding an adjustment value to a first detection voltage value corresponding to the first target ion; and in detection of the first target ion, applying a voltage having the first detection voltage value to the electrode, wherein the adjustment value is a value indicating a polarity opposite to a polarity of the first target ion.

### Advantageous Effects of Invention

According to an aspect of the present disclosure, a difference in analysis conditions between when a gas is not introduced into a collision cell during analysis in an ICP mass spectrometer and when the gas is introduced into the collision cell becomes smaller.

### BRIEF DESCRIPTION OF DRAWINGS

FIG. 1 schematically shows a configuration of a mass spectrometer according to the present embodiment.

FIG. 2 shows an enlarged view of a part of a mass spectrometer 100.

FIG. 3 shows one example of a set of set values for each electrode in analysis without gas.

FIG. 4 shows one example of sets of set values used for a time period during which mass spectrometer 100 causes an ion detector 17 to detect ions to be analyzed.

FIG. 5 shows one example of sets of set values used for adjustment for a time period other than the time period during which mass spectrometer 100 causes ion detector 17 to detect the ions to be analyzed.

FIG. 6 is a flowchart of a process performed to analyze a sample in mass spectrometer 100.

FIG. 7 schematically shows the timing of application of voltages having adjustment voltage values in the process shown in FIG. 6.

FIG. 8 is a diagram for illustrating the omission of application of the voltages having the adjustment voltage values.

FIG. 9 shows a change in amount of an argon ion detected in analysis of a given sample in a mass spectrometer according to a comparative example.

FIG. 10 shows detection results about ions to be analyzed in each of analysis with gas and analysis without gas.

FIG. 11 shows detection results about ions to be analyzed in each of analysis with gas and analysis without gas.

FIG. 12 shows maximum change rates at the start of detection about the detected intensities shown in FIG. 11.

FIG. 13 is a flowchart according to a modification of the process shown in FIG. 6.

### DESCRIPTION OF EMBODIMENTS

Embodiments of the present disclosure will be described in detail below with reference to the drawings, in which the same or corresponding portions are denoted by the same reference characters and description thereof will not be repeated.

### Configuration of Mass Spectrometer

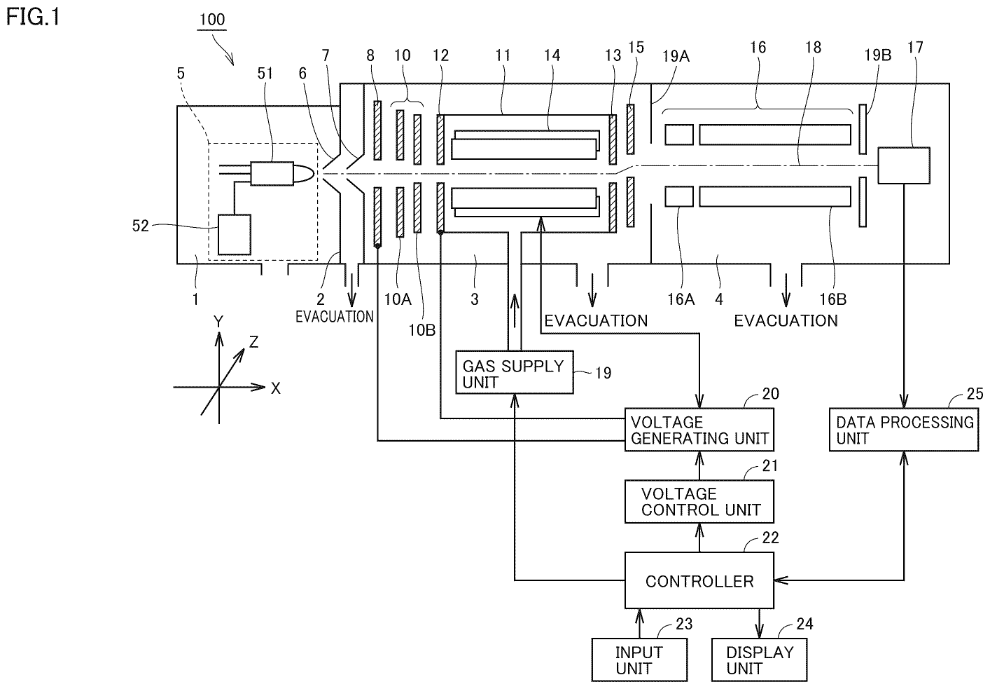

FIG. 1 schematically shows a configuration of a mass spectrometer according to the present embodiment. A mass spectrometer 100 shown in FIG. 1 is an ICP mass spectrometer.

Mass spectrometer 100 includes an ionization chamber 1, a first vacuum chamber 2, a second vacuum chamber 3, and a third vacuum chamber 4. Ionization chamber 1 has a substantially atmospheric pressure and is electrically grounded. First vacuum chamber 2 is configured such that a degree of vacuum becomes higher sequentially from the ionization chamber 1 side. First vacuum chamber 2 is evacuated by a rotary pump. Second vacuum chamber 3 and third vacuum chamber 4 are evacuated by a rotary pump and a turbo molecular pump.

An ICP ion source 5 is disposed in ionization chamber 1. A configuration of ICP ion source 5 shown in FIG. 1 is merely one example and can be modified variously.

ICP ion source 5 includes a plasma torch 51. Plasma torch 51 includes a sample tube through which a liquid sample atomized by a nebulizing gas flows, a plasma gas tube formed on an outer circumference of the sample tube, and a cooling gas tube formed on an outer circumference of the plasma gas tube.

An autosampler 52 that introduces the liquid sample into plasma torch 51 is provided at an entrance end of the sample tube of plasma torch 51. Although not shown, a nebulizing gas source that supplies the nebulizing gas is also connected to the sample tube, a plasma gas source that supplies a plasma gas (e.g., an Ar gas) is connected to the plasma gas tube, and a cooling gas source that supplies a cooling gas is connected to the cooling gas tube.

First vacuum chamber 2 is formed between a sampling cone 6 having a substantially conical shape, and a skimmer cone 7 also having a substantially conical shape. Each of sampling cone 6 and skimmer cone 7 has an ion passage port at a top thereof. Skimmer cone 7 is, for example, made of a metal such as Cu or Ni. First vacuum chamber 2 functions as an interface for transmitting ions supplied from ICP ion source 5 to a subsequent stage and discharging a solvent gas and the like.

Of the three axes (X, Y and Z) shown in FIG. 1, the X axis indicates the ion traveling direction.

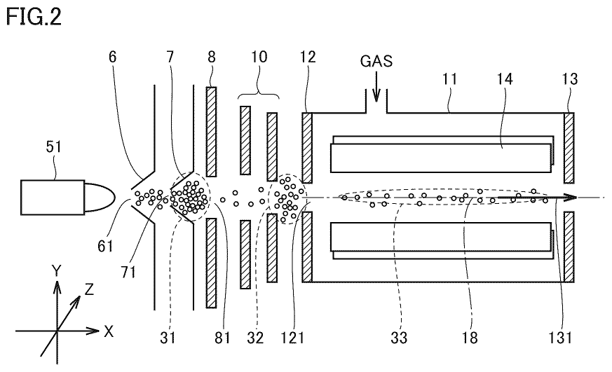

In second vacuum chamber 3, a pull-in electrode 8, an ion lens 10 that converges the ions, and a collision cell 11 are arranged sequentially from the skimmer cone 7 side (the ion incident side). Ion lens 10 includes a front-side electrode 10A and a rear-side electrode 10B. Each of pull-in electrode 8 and ion lens 10 is a disk-shaped electrode having a substantially circular opening for allowing the ions to pass therethrough. In FIG. 2, the opening of pull-in electrode 8 is shown as an opening 81.

An entrance electrode 12 having an ion passage opening 121 is arranged on the entrance side of collision cell 11, and an exit electrode 13 having an ion passage opening 131 is arranged on the exit side of collision cell 11. A multipole (e.g., octopole)-type ion guide 14 including a plurality of rod electrodes arranged parallel to an ion optical axis 18 is disposed in collision cell 11. Exit electrode 13 also functions as an electrode for forming an energy barrier.

An axis bending electrode 15 and an axis bending exit electrode 19A are arranged in a subsequent stage of exit electrode 13. Each of axis bending electrode 15 and axis bending exit electrode 19A is a disc-shaped electrode having a substantially circular opening for allowing the ions to pass therethrough. The position of the opening in each of axis bending electrode 15 and axis bending exit electrode 19A is such that the opening is located in an upper part in the Y-axis direction toward third vacuum chamber 4. Thus, ion optical axis 18 is bent by axis bending electrode 15 and axis bending exit electrode 19A. That is, the location where ion optical axis 18 is present in collision cell 11 is different in the Y-axis direction (located in the upper part in FIG. 1) from the location where ion optical axis 18 is present in a quadrupole mass filter 16 inside third vacuum chamber 4.

Quadrupole mass filter 16 and an ion detector 17 are arranged in third vacuum chamber 4. Quadrupole mass filter 16 includes a pre-rod electrode 16A and a main rod electrode 16B. An entrance electrode 19B is arranged between ion detector 17 and main rod electrode 16B. Entrance electrode 19B is a disc-shaped electrode having a substantially circular opening for allowing the ions to pass therethrough.

A gas supply unit 19 supplies a collision gas or a reaction gas into collision cell 11 through a gas supply tube. The collision gas is He (or another inert gas), and the reaction gas is a reactive gas such as hydrogen or ammonia.

A voltage generating unit 20 generates a voltage applied to each unit in mass spectrometer 100. In FIG. 1, only a part of voltage supply lines are shown in order to avoid complicated illustrations. Voltage generating unit 20 includes a plurality of direct current (DC) voltage generating units that generate a DC voltage having a prescribed voltage, and a plurality of high-frequency voltage generating units that generate a high-frequency voltage having a prescribed amplitude and a prescribed frequency.

A voltage controller 21 controls the magnitude of the voltage applied from voltage generating unit 20 to each unit and the timing of application under control by a controller 22.

Controller 22 comprehensively controls each unit in mass spectrometer 100 to perform analysis. Controller 22 also functions as a user interface through an input unit 23, a display unit 24 and the like. A data processing unit 25 includes an analog-to-digital (AD) converter that digitalizes a detection signal obtained in ion detector 17, and processes collected data to perform processing such as creation of a mass spectrum.

In one implementation, each of controller 22, voltage controller 21 and data processing unit 25 is implemented by a personal computer including a central processing unit (CPU), a random access memory (RAM), an external storage device and the like. In one implementation, the control in mass spectrometer 100 can be implemented by the CPU performing a pre-installed prescribed program.

### One Example of Analysis Operation by Mass Spectrometer

FIG. 2 shows an enlarged view of a part of mass spectrometer 100. One example of an analysis operation by mass spectrometer 100 will be described below. In the description below, in mass spectrometer 100, an ion to be detected is a positive ion. It is clear that even when the ion to be detected is a negative ion, analysis similar to the analysis in the description below becomes possible by appropriately changing, for example, a polarity of the voltage applied to each unit.

In addition, in the present specification, a positive or negative voltage value applied to each electrode is associated with a polarity of the ion to be detected. More specifically, when the ion to be detected is a positive ion, a positive voltage value (e.g., +1.0 V) is a voltage value indicating the same polarity as the polarity of the ion to be detected, and a negative voltage value (e.g., −1.0 V) is a voltage value indicating a polarity opposite to the polarity of the ion to be detected. In contrast, when the ion to be detected is a negative ion, a positive voltage value is a voltage value indicating a polarity opposite to the polarity of the ion to be detected, and a negative voltage value is a voltage value indicating the same polarity as the polarity of the ion to be detected.

In a standby state before the start of analysis, each of first vacuum chamber 2, second vacuum chamber 3 and third vacuum chamber 4 is in an evacuated state. When an instruction to start analysis is provided from a user through input unit 23, or when an instruction to start analysis is automatically provided in accordance with a preset automatic analysis program, controller 22 starts analysis preparation work.

In the analysis preparation work, controller 22 actuates gas supply unit 19 to start to supply a prescribed gas into collision cell 11 continuously or intermittently. The type of the supplied gas varies depending on an analysis mode. An He gas is, for example, supplied in a collision mode, and an H₂ gas is, for example, supplied in a reaction mode.

Mass spectrometer 100 requires a certain amount of time until collision cell 11 is filled with the gas and the gas becomes stable after the gas starts to be supplied into collision cell 11, and mass spectrometer 100 cannot perform substantial analysis during this time period. This time period corresponds to an analysis preparation period.

In response to an instruction from controller 22, voltage controller 21 controls voltage generating unit 20 to apply a positive DC voltage having a prescribed voltage value to pull-in electrode 8 such that a potential barrier higher than the initial energy of undesirable ions generated in ICP ion source 5 is formed between skimmer cone 7 and pull-in electrode 8. “Undesirable ions” are mainly ions derived from the plasma gas used in ICP ion source 5, and when the plasma gas is Ar, the undesirable ions are Ar⁺, Ar²⁺ and the like. Since the initial energy of the “undesirable ions” is not so large, the voltage applied to pull-in electrode 8 is generally approximately+several volts.

In addition, under the instruction from controller 22, voltage controller 21 controls voltage generating unit 20 to apply a positive DC voltage having a prescribed voltage value to entrance electrode 12 of collision cell 11. The voltage applied to entrance electrode 12 at this time is, for example, approximately +tens of volts to 200 volts.

In addition, under the instruction from controller 22, voltage controller 21 controls voltage generating unit 20 to apply a high-frequency voltage having an amplitude value larger than an amplitude value during normal analysis to ion guide 14 in collision cell 11.

Furthermore, voltage controller 21 controls voltage generating unit 20 to apply, continuously or in a pulselike manner, a negative DC voltage having a prescribed voltage value larger than a voltage value during normal analysis to exit electrode 13 of collision cell 11. At this time, the amplitude value of the high-frequency voltage applied to ion guide 14 is, for example, 50 volts or more, and the DC voltage applied to exit electrode 13 is, for example, approximately −100 volts (approximately −10 to −some dozen volts during normal analysis).

As described above, due to the DC voltage applied to pull-in electrode 8, the potential barrier is formed in the vicinity of pull-in electrode 8 by an electric field having the same polarity as a polarity of the ions. The ions derived from the plasma gas and the like, which have been generated in ICP ion source 5 and entered second vacuum chamber 3 through the ion passage port (opening 61) of sampling cone 6 and the ion passage port (opening 71) of skimmer cone 7, are blocked by the above-described potential barrier. Therefore, the ions stay in a region 31 between skimmer cone 7 and pull-in electrode 8, which makes the density of the ions higher.

In addition to the above-described ions, reactive neutral particles and plasma gas molecules that are derived from the plasma gas try to enter the vacuum region from ICP ion source 5. However, since the density of the ions in region 31 is high, the reactive neutral particles and the gas molecules having passed through opening 71 of skimmer cone 7 come into contact with the ions easily. The reactive neutral particles and the gas molecules having come into contact with the ions change the trajectories thereof, and collide with the surrounding electrode and the like and disappear, or are discharged from second vacuum chamber 3 to the outside. Therefore, the reactive neutral particles and the gas molecules are less likely to reach the entrance of collision cell 11, and thus, an amount of the reactive neutral particles and the gas molecules entering collision cell 11 can be reduced.

As described above, due to the voltage applied to entrance electrode 12 of collision cell 11, the electric field having the same polarity as a polarity of the ions derived from the plasma gas and the like is formed in a region 32 between ion lens 10 and entrance electrode 12. Therefore, the ions that have been introduced from ICP ion source 5 through first vacuum chamber 2 to second vacuum chamber 3 and passed through region 32 are pushed back before entrance electrode 12. Thus, entry of the undesirable ions derived from the plasma gas and the like into collision cell 11 can be further reduced.

Since the reactive neutral particles and the molecules do not have any electric charge, the reactive neutral particles and the molecules are not removed by the action of the electric field formed in region 32. However, the reactive neutral particles and the molecules do not easily pass through region 31 as described above, and thus, the amount of the reactive neutral particles and the gas molecules entering collision cell 11 is small.

A part of the ions derived from the plasma gas and the like may in some cases pass through both region 31 and region 32 and enter collision cell 11. In addition, a part of the reactive neutral particles and the molecules that are derived from the plasma gas and the like may in some cases pass through the above-described two regions and enter collision cell 11, and come into contact with the gas in collision cell 11 to become undesirable ions. The ions coming from the outside and the ions generated in collision cell 11 come into contact with the gas present in collision cell 11 and decrease the energy thereof, and are captured by the high-frequency electric field formed by ion guide 14. Since the high-frequency electric field at this time is stronger than a high-frequency electric field during normal analysis, the ions are converged in a relatively narrow region 33 in the vicinity of ion optical axis 18.

As described above, a relatively high voltage having a polarity opposite to a polarity of the captured ions is applied to exit electrode 13 of collision cell 11. Therefore, the ions staying in region 33 are induced by the strong electric field formed by the voltage applied to exit electrode 13, and are discharged from collision cell 11 through ion passage opening 131 of exit electrode 13.

That is, during the analysis preparation period before analysis is performed, entry of the undesirable ions and the undesirable reactive neutral particles into collision cell 11 is suppressed between ICP ion source 5 and collision cell 11. The undesirable ions having entered collision cell 11 and the undesirable ions generated in collision cell 11 are quickly discharged to the outside of collision cell 11. In this way, in mass spectrometer 100, the ions are less likely to stay in collision cell 11 during the analysis preparation period.

Controller 22 awaits until a predetermined prescribed waiting time elapses such that collision cell 11 is sufficiently filled with the gas supplied from gas supply unit 19. The gas introduced into collision cell 11 leaks from the openings (ion passage openings 121 and 131) of entrance electrode 12 and exit electrode 13. Therefore, the longer waiting time is more preferable in order to allow collision cell 11 to be filled with the gas molecules at a density that is as uniform as possible. As one example, the waiting time from the start of introduction of the gas may be equal to or longer than 40 seconds.

When the prescribed waiting time elapses, voltage controller 21 controls voltage generating unit 20 to apply a negative DC voltage having a prescribed voltage value to pull-in electrode 8 to pull in the ions. In addition, voltage controller 21 controls voltage generating unit 20 to apply a negative DC voltage having a prescribed voltage value to entrance electrode 12 of collision cell 11 as well. In addition, voltage controller 21 controls voltage generating unit 20 to apply a high-frequency voltage having a prescribed amplitude value corresponding to a component to be analyzed (target component) to ion guide 14 in collision cell 11. In addition, voltage controller 21 controls voltage generating unit 20 to apply a prescribed voltage for forming a potential barrier to exit electrode 13 of collision cell 11.

Thereafter, analysis is performed in mass spectrometer 100. In one implementation, voltage controller 21 sets a voltage applied to quadrupole mass filter 16, so as to allow ions derived from the target component to pass therethrough. In mass spectrometer 100, after a time period (e.g., approximately several milliseconds) required for settling of the voltage applied to each unit elapses, an intensity of the ions of the target sample component is detected.

For example, in the collision mode, the ions derived from the sample component, which has been generated in ICP ion source 5, are introduced into collision cell 11 filled with the collision gas, together with the undesirable ions derived from the plasma gas. The introduced ions collide with the collision gas repeatedly and the energy thereof is attenuated. An ion having a larger collision cross-sectional area collides with the collision cell more frequently and the energy thereof is attenuated more greatly. Normally, the ions derived from the plasma gas are larger in collision cross-sectional area than the ions derived from the target component, and thus, the ions derived from the plasma gas are smaller in kinetic energy. Therefore, the ions derived from the plasma gas do not easily go across the potential barrier formed at the exit of collision cell 11. In this way, the unwanted ions derived from the plasma gas and the like can be removed by a kinetic energy discrimination method, and the ions of the sample component can be mainly fed into quadrupole mass filter 16 and analyzed.

As described above, since there are very few ions in collision cell 11 during the analysis preparation period before the start of analysis, the ions staying in collision cell 11 have little space charge effect at the start of analysis of the ions derived from the target component. Therefore, the trajectories of the ions derived from the target component (introduced into collision cell 11) are not affected by the above-described space charge effect during analysis. Thus, the ions are introduced through collision cell 11 into quadrupole mass filter 16 in accordance with the normal trajectories. As a result, an amount of the ions derived from the target component, which finally reach ion detector 17, is increased and high analytical sensitivity can be achieved. In addition, since the trajectories of the ions derived from the sample component are not affected by the above-described space charge effect, a drift of the ion intensity can also be reduced, and further, variations in drift due to the type of the sample component can also be reduced.

In the description above, the voltage applied to each unit is set to prevent the ions from staying in collision cell 11 over the entire analysis preparation period from when the gas starts to be supplied into collision cell 11 to when collision cell 11 is sufficiently filled with the gas and analysis is started. However, such voltage setting does not necessarily need to be continued over the entire analysis preparation period. Even in the reaction mode, not in the collision mode, the basic operation may be similar to the above.

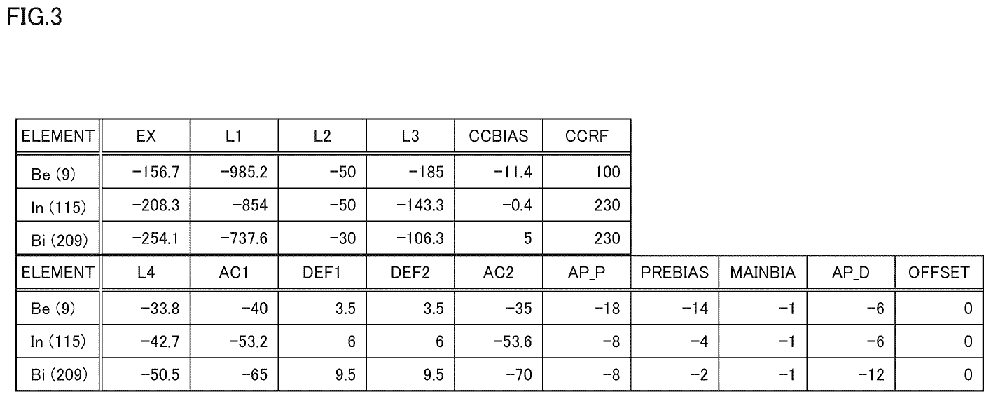

When the target ion is a positive ion, a negative voltage value is applied to quadrupole mass filter 16 (each of pre-rod electrode 16A and main rod electrode 16B). Specific examples of the applied voltage value will be described below with reference to FIGS. 3 to 5.

### Specific Examples of Applied Voltage Value

### Analysis without Gas

FIG. 3 shows one example of a set of set values for each electrode in analysis without gas. In mass spectrometer 100, the analysis without gas refers to analysis performed without supplying the gas to collision cell 11. In one implementation, the sets of set values shown in FIG. 3 are stored in a memory of controller 22.

FIG. 3 shows three types of element names (Be, In and Bi) as ions to be detected. The mass-to-charge ratio is appended to each element name.

FIG. 3 shows a combination of set values for the ions (elements) to be detected, for each of the sixteen types of electrodes described below. Each set value is expressed in the unit volt (V). Each of the sixteen types of symbols such as EX shown in FIG. 3 indicates a voltage value applied to each electrode described below.
EX: pull-in electrode 8
L1: front-side electrode 10A of ion lens 10
L2: rear-side electrode 10B of ion lens 10
L3: entrance electrode 12 of collision cell 11
CCBIAS: bias electrode corresponding to the rod electrode of ion guide 14
CCRF: reference electrode corresponding to the rod electrode of ion guide 14
L4: exit electrode 13 of collision cell 11
AC1: axis bending electrode 15(1)
DEF1: axis bending electrode 15(2)
DEF2: axis bending electrode 15(3)
AC2: axis bending electrode 15(4)
AP_P: axis bending exit electrode 19A
PREBIAS: pre-rod electrode 16A of quadrupole mass filter 16
MAINBIA: main rod electrode 16B of quadrupole mass filter 16
AP_D: entrance electrode 20B (between ion detector 17 and main rod electrode 16B)
OFFSET: bias electrode of quadrupole mass filter 16

Of the above-described sixteen types, “axis bending electrode 15(1)”, “axis bending electrode 15(2)”, “axis bending electrode 15(3)”, and “axis bending electrode 15(4)” refer to four portions that make up axis bending electrode 15. These are arranged in the order of “axis bending electrode 15(1)”, “axis bending electrode 15(2)”, “axis bending electrode 15(3)”, and “axis bending electrode 15(4)” in the X-axis direction when viewed from the ionization chamber 1 side. That is, “axis bending electrode 15(1)” is located between collision cell 11 and “axis bending electrode 15(2)”. “Axis bending electrode 15(4)” is located between “axis bending electrode 15(3)” and axis bending exit electrode 19A.

In the example shown in FIG. 3, for at least a part of the electrodes, the different set values are provided for the respective ions to be detected.

### Analysis with Gas

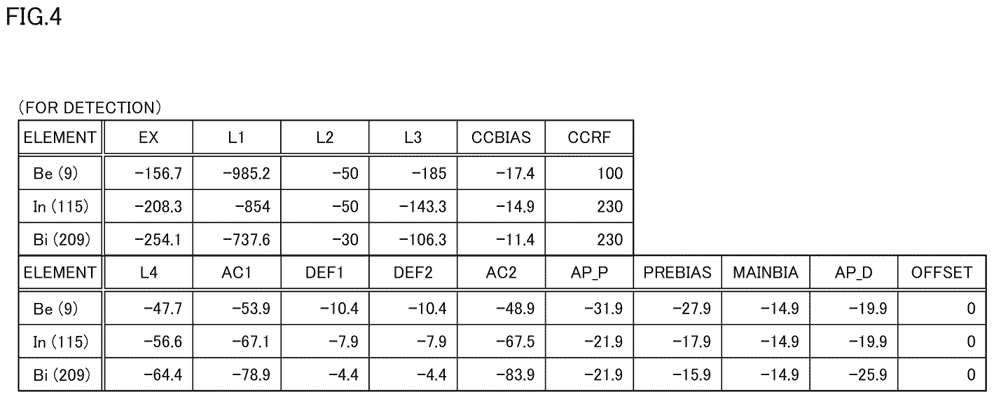

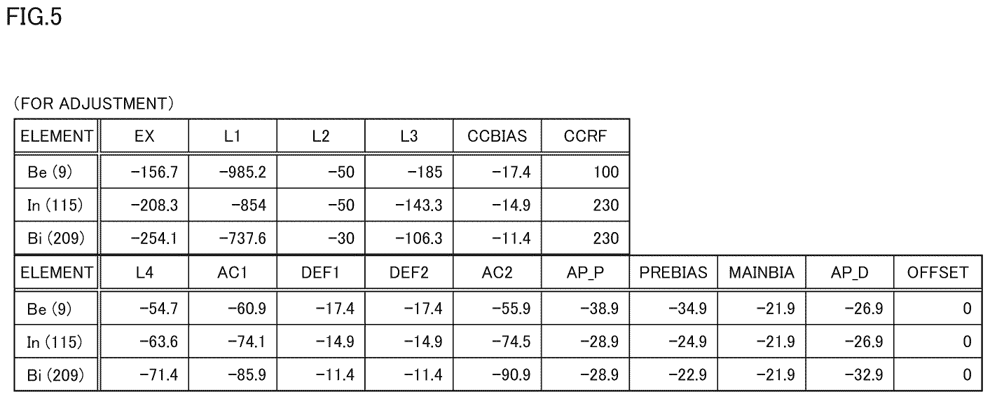

Each of FIGS. 4 and 5 shows one example of a set of set values for each electrode in analysis with gas. In mass spectrometer 100, the analysis with gas refers to analysis performed with the gas supplied to collision cell 11. Each set value is expressed in the unit volt (V). In one implementation, the sets of set values shown in each of FIGS. 4 and 5 are stored in the memory of controller 22.

FIG. 4 shows one example of sets of set values used for a time period during which mass spectrometer 100 causes ion detector 17 to detect the ions to be analyzed. FIG. 5 shows one example of sets of set values used for adjustment for a time period other than the time period during which mass spectrometer 100 causes ion detector 17 to detect the ions to be analyzed. Similarly to FIG. 3, in FIGS. 4 and 5 as well, for at least a part of the electrodes, the different set values are provided for the respective ions to be detected.

In FIGS. 4 and 5, a combination of set values for each of the six types of electrodes (“EX”, “L1”, “L2”, “L3”, “CCBIAS”, and “CCRF”) in the upper row and the one type of electrode (“OFFSET”) in the lower row is common to FIGS. 4 and 5, whereas a combination of set values for the nine types of electrodes (“L4”, “AC1”, “DEF1”, “DEF2”, “AC2”, “AP_P”, “PREBIAS”, “MAINBIA”, and “AP_D”) in the lower row is different between FIGS. 4 and 5. More specifically, an absolute value of each of the set values shown in FIG. 5 is larger than an absolute value of each of the set values shown in FIG. 4.

In the examples shown in FIGS. 3 to 5, the three types of ions to be detected are positive ions (Be⁺, In⁺ and Bi⁺). Thus, the set values for the nine types of electrodes in the lower row shown in each of FIGS. 4 and 5 are all negative voltage values. The absolute values of the set values for the nine types of electrodes in the lower row shown in FIG. 5 are larger than the absolute values of the set values for the nine types of electrodes in the lower row shown in FIG. 4. This means that the set values for the nine types of electrodes in the lower row shown in FIG. 5 are obtained by adding a value (negative value) indicating a polarity opposite to a polarity of the ions to be detected to the set values for the nine types of electrodes in the lower row shown in FIG. 4. In the present specification, the value added to the values shown in FIG. 4 to obtain the values shown in FIG. 5 will also be referred to as “adjustment value”.

In the example shown in FIGS. 4 and 5, the adjustment value for all of the voltage values for the nine types of electrodes in the lower row is “−7.0 (V)”.

For example, as for “L4” in the case of element Be, the set value shown in FIG. 4 is “−47.7 (V)”, and the set value shown in FIG. 5 is “−54.7 (V)”. The latter is obtained by adding “−7.0 (V)” to the former.

In addition, as for “PREBIAS” in the case of element Be, the set value shown in FIG. 4 is “−27.9 (V)”, and the set value shown in FIG. 5 is “−34.9 (V)”. The latter is obtained by adding “−7.0 (V)” to the former.

### Flow of Process

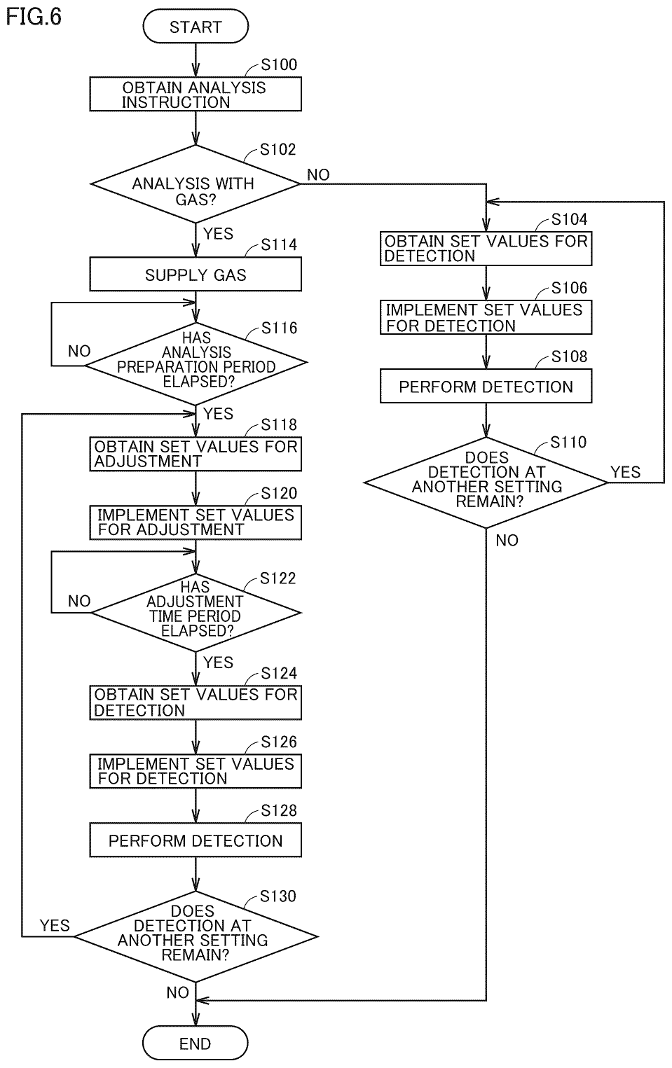

FIG. 6 is a flowchart of a process performed to analyze a sample in mass spectrometer 100. The process shown in FIG. 6 is, for example, performed by the CPU performing a given program. Details of the process shown in FIG. 6 will be described below.

Referring to FIG. 6, in step S100, mass spectrometer 100 obtains an analysis instruction. In one implementation, the user inputs the analysis instruction to input unit 23. Mass spectrometer 100 may obtain the analysis instruction through input unit 23.

In step S102, mass spectrometer 100 determines whether the instructed analysis is analysis with gas. In one implementation, the analysis instruction input to input unit 23 by the user may include designation of analysis with gas or analysis without gas. Mass spectrometer 100 obtains the designation of analysis with gas or analysis without gas through input unit 23.

When the instructed analysis includes the designation of analysis with gas (YES

in step S102), mass spectrometer 100 advances the control to step S114. Otherwise (NO in step S102), mass spectrometer 100 advances the control to step S104. That is, when the instructed analysis includes the designation of analysis without gas, the control proceeds to step S104.

In step S104, mass spectrometer 100 obtains set values for respective electrodes for respective ions to be detected in analysis.

In analysis of the sample, mass spectrometer 100 causes ion detector 17 to obtain a detection signal of each of one or more types of ions. In the process shown in FIG. 6, step S104 to step S108 are performed for each of the types of ions to be detected. When two or more types of ions are to be detected, step S104 to step S108 are repeated the number of times corresponding to the number of the types of ions to be detected.

In one implementation, mass spectrometer 100 obtains set values for the ions to be detected, for the sixteen types of electrodes shown in FIG. 3.

In step S106, mass spectrometer 100 implements the set values obtained in step S104. That is, mass spectrometer 100 applies voltages having the obtained set values to the respective electrodes.

In step S108, mass spectrometer 100 controls each element in mass spectrometer 100 in order to cause ion detector 17 to obtain the detection signals of the ions to be detected. Detection, by ion detector 17, of the ions to be detected is thus performed.

In step S110, mass spectrometer 100 determines whether detection at another setting remains about the sample to be analyzed. More specifically, mass spectrometer 100 determines whether there is an ion that is not yet a detection target, of two or more types of ions, when detection of the two or more types of ions is performed in the ongoing analysis. When there is an ion that is not yet a detection target, mass spectrometer 100 determines that detection at another setting remains.

When mass spectrometer 100 determines that detection at another setting remains (YES in step S110), mass spectrometer 100 returns the control to step S104. Otherwise, mass spectrometer 100 ends the process shown in FIG. 6.

In step S114, mass spectrometer 100 causes gas supply unit 19 to supply the gas to collision cell 11.

In step S116, mass spectrometer 100 determines whether the “analysis preparation period” described above has elapsed since the start of supply of the gas to collision cell 11. Mass spectrometer 100 repeats the determination in step S116 until mass spectrometer 100 determines that the analysis preparation period has elapsed (NO in step S116). When mass spectrometer 100 determines that the analysis preparation period has elapsed (YES in step S116), mass spectrometer 100 advances the control to step S118.

In step S118, mass spectrometer 100 obtains adjustment voltage values for the ions to be detected, for the sixteen types of electrodes shown in FIG. 5. Similarly to the analysis without gas, in the analysis with gas as well, mass spectrometer 100 causes ion detector 17 to obtain the detection signals of one or more types of ions. When two or more types of ions are to be detected, step S118 to step S128 are repeated the number of times corresponding to the number of the types of ions to be detected. In step S118, the adjustment voltage values are obtained for the ion that is a detection target at this point in time.

In step S120, mass spectrometer 100 implements the adjustment voltage values obtained in step S118. That is, mass spectrometer 100 applies voltages having the obtained adjustment voltage values to the respective electrodes.

In step S122, mass spectrometer 100 determines whether a time period (adjustment time period) set to apply the voltages having the adjustment voltage values to the respective electrodes has elapsed since the implementation of the adjustment voltage values in step S118. Mass spectrometer 100 repeats the determination in step S122 until mass spectrometer 100 determines that the adjustment time period has elapsed (NO in step S122). When mass spectrometer 100 determines that the adjustment time period has elapsed (YES in step S122), mass spectrometer 100 advances the control to step S124.

In step S124, mass spectrometer 100 obtains detection set values for the ions to be detected, for the sixteen types of electrodes shown in FIG. 4.

In step S126, mass spectrometer 100 implements the detection set values obtained in step S124. That is, mass spectrometer 100 applies voltages having the obtained detection set values to the respective electrodes.

In step S128, mass spectrometer 100 controls each element in mass spectrometer 100 in order to cause ion detector 17 to obtain the detection signals of the ions to be detected. Detection, by ion detector 17, of the ions to be detected is thus performed.

Similarly to step S110, in step S130, mass spectrometer 100 determines whether detection at another setting remains about the sample to be analyzed. When mass spectrometer 100 determines that detection at another setting remains (YES in step S130), mass spectrometer 100 returns the control to step S118. Otherwise, mass spectrometer 100 ends the process shown in FIG. 6.

### Adjustment Voltage Value

In the present embodiment described above, mass spectrometer 100 receives the designation of analysis with gas or analysis without gas as a method for analyzing the sample. When mass spectrometer 100 receives the designation of analysis with gas, mass spectrometer 100 implements “adjustment voltage values” in step S120 before the detection, by ion detector 17, of the ions to be detected (step S128). The voltage values implemented in the respective electrodes during the detection, by ion detector 17, of the ions to be detected are referred to as “detection voltage values”.

As described with reference to FIGS. 4 and 5, for each of the nine types of electrodes (“L4”, “AC1”, “DEF1”, “DEF2”, “AC2”, “AP_P”, “PREBIAS”, “MAINBIA”, and “AP_D”) located on the downstream side of collision cell 11 in the ion traveling direction, of the sixteen types of electrodes, “adjustment voltage value” when the target ion is “Be” (Be⁺) is obtained by adding “−7.0 (V)” to “detection voltage value”.

“−7.0 (V)” herein is one example of the adjustment value. The adjustment value is a value indicating a polarity opposite to a polarity of a target ion. For example, when the target ion is a positive ion, the adjustment value has a negative value. When the target ion is a negative ion, the adjustment value has a positive value.

The above-described nine types of electrodes include pre-rod electrode 16A (PREBIAS) and main rod electrode 16B (MAINBIA) of quadrupole mass filter 16. In this sense, each of pre-rod electrode 16A and main rod electrode 16B is one example of the electrode to which the voltage having the adjustment voltage value is applied.

The above-described nine types of electrodes include exit electrode 13 of collision cell 11 provided between collision cell 11 and quadrupole mass filter 16. In this sense, exit electrode 13 is one example of the electrode to which the voltage having the adjustment voltage value is applied.

The above-described nine types of electrodes include entrance electrode 20B (AP_D) provided between quadrupole mass filter 16 and ion detector 17. In this sense, entrance electrode 20B is one example of the electrode to which the voltage having the adjustment voltage value is applied.

The above-described nine types of electrodes include axis bending electrode 15 (AC1, DEF1, DEF2, AC2) and axis bending exit electrode 19A (AP_P) provided between collision cell 11 and quadrupole mass filter 16 to connect an ion optical axis in collision cell 11 and an ion optical axis in quadrupole mass filter 16 in a given direction (Y-axis direction). In this sense, each of axis bending electrode 15 and exit electrode 19A is one example of the electrode to which the voltage having the adjustment voltage value is applied.

As described with reference to FIGS. 4 and 5, “detection voltage value” and “adjustment voltage value” are set for each target ion and for each electrode.

For example, for exit electrode 13 (L4) of collision cell 11, the detection voltage value and the adjustment voltage value are set for each of the three types of target ions. More specifically, for the Be ion, −47.7 (V) is set as the detection voltage value and −54.7 (V) is set as the adjustment voltage value. For the In ion, −56.6 (V) is set as the detection voltage value and −63.6 (V) is set as the adjustment voltage value. For the Bi ion, −64.4 (V) is set as the detection voltage value and −71.4 (V) is set as the adjustment voltage value.

For exit electrode 13 (L4) of collision cell 11, the detection voltage value is obtained by adding “−7.0 (V)” to the adjustment voltage value, for any of the above-described three types of target ions. That is, the adjustment value may be common to a plurality of types of target ions.

However, the example shown in FIGS. 4 and 5 is merely one example. Different voltage values may be set as the adjustment value, depending on the type of target ion and/or depending on the electrode.

### Start Timing of Implementation of Adjustment Voltage Value

In the process shown in FIG. 6, mass spectrometer 100 starts to supply the gas to collision cell 11 in step S114, awaits the passage of the analysis preparation period in step S116, and then, applies the voltages having the adjustment voltage values to the respective electrodes in step S120.

The voltages having the adjustment voltage values are applied to reduce a difference in analysis conditions between the analysis with gas and the analysis without gas. More specifically, in the analysis with gas, the kinetic energy of the interference ions decreases due to contact with the gas in collision cell 11, and thus, charge up caused by the interference ions is less likely to occur in quadrupole mass filter 16 and the like, as compared with the analysis without gas. Accordingly, in the analysis with gas, the voltages having the adjustment voltage values are applied before the detection of the target ion, in order to bring an amount of occurrence of charge up closer to that of the analysis without gas. As described above, since the application of the voltages having the adjustment voltage values is started after the supply of the gas to collision cell 11 is started, the application of the voltages is performed within a necessary minimum range.

However, the application of the voltages having the adjustment voltage values to the respective electrodes may be started without awaiting the passage of the analysis preparation period or before the supply of the gas to collision cell 11 is started.

### Frequency of Implementation of Adjustment Voltage Value

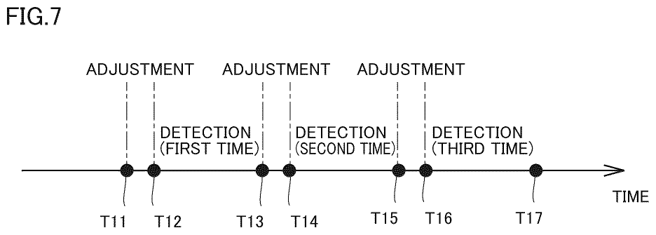

In the process shown in FIG. 6, in the analysis with gas, every time the detection of the target ion is performed in step S128, the voltages having the adjustment voltage values are applied to the respective electrodes in step S120 before the detection. That is, the timing of the application of the voltages having the adjustment voltage values in the process shown in FIG. 6 is shown in FIG. 7. FIG. 7 schematically shows the timing of the application of the voltages having the adjustment voltage values in the process shown in FIG. 6.

In the example shown in FIG. 7, in a time period from time T11 to time T12, the application of the voltages having the adjustment voltage values to the respective voltages before the first analysis of the target ion is performed. In a time period from time T12 to time T13, the first analysis of the target ion is performed. In a time period from time T13 to time T14, the application of the voltages having the adjustment voltage values to the respective voltages before the second analysis of the target ion is performed. In a time period from time T14 to time T15, the second analysis of the target ion is performed. In a time period from time T15 to time T16, the application of the voltages having the adjustment voltage values to the respective voltages before the third analysis of the target ion is performed. In a time period from time T16 to time T17, the third analysis of the target ion is performed.

For example, in analysis of a sample, a Be ion is detected in the first detection, an In ion is detected in the second detection, and a Bi ion is detected in the third detection. The first detection to the third detection are performed as analysis with gas.

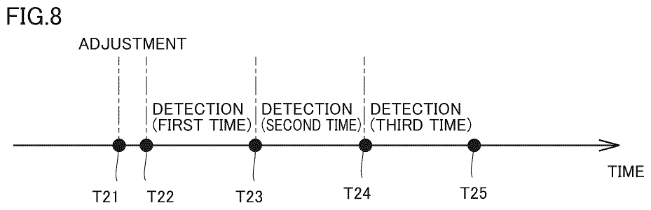

When a plurality of times of detections are continuously performed in analysis with gas, the application of the voltages having the adjustment voltage values between the detections may be omitted. FIG. 8 is a diagram for illustrating the omission of the application of the voltages having the adjustment voltage values.

In the example shown in FIG. 8, in a time period from time T21 to time T22, the application of the voltages having the adjustment voltage values to the respective voltages before the first analysis of the target ion is performed. In a time period from time T22 to time T23, the first analysis of the target ion is performed. In a time period from time T23 to time T24, the second analysis of the target ion is performed. In a time period from time T24 to time T25, the third analysis of the target ion is performed.

### Difference in Amount of Occurrence of Charge Up between Analysis with Gas and Analysis without Gas

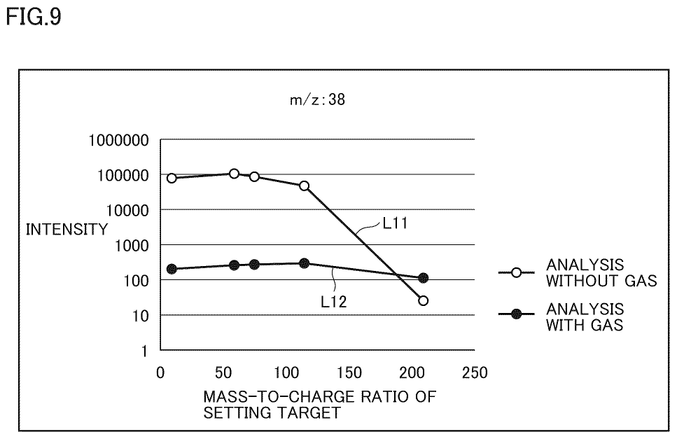

A difference in amount of occurrence of charge up between the analysis with gas and the analysis without gas will be described with reference to FIGS. 9 to 12.

### Amount of Detection of Argon Ion

FIG. 9 shows a change in amount of an argon ion detected in analysis of a given sample in a mass spectrometer according to a comparative example. The change shown in FIG. 9 is treated as the comparative example.

In the graph shown in FIG. 9, the vertical axis indicates an intensity of a detection signal of the argon ion (mass-to-charge ratio (m/z)=38) in ion detector 17. The horizontal axis indicates a mass-to-charge ratio targeted by the set values of the voltages applied to the sixteen types of electrodes (see FIG. 3 and the like) in mass spectrometer 100.

As described with reference to FIGS. 3 and 4, the set value of the voltage applied to each electrode changes in accordance with the mass-to-charge ratio of the ion to be detected by mass spectrometer 100. For example, for electrode PREBIAS in the analysis without gas (FIG. 3), the set value is “−14 (V)” when the mass-to-charge ratio of the ion to be detected is “9” (Be), and the set value is “−4 (V)” when the mass-to-charge ratio of the ion to be detected is “115” (In), and the set value is “−12 (V)” when the mass-to-charge ratio of the ion to be detected is “209” (Bi).

The graph shown in FIG. 9 shows a change in amount of the argon ion introduced into collision cell 11 and arriving at ion detector 17 in accordance with a change in set value of the voltage applied to each electrode. In FIG. 9, a line L11 indicates a result in the analysis without gas. A line L12 indicates a result in the analysis with gas. The analysis with gas in FIG. 9 does not include the application of the adjustment voltage values (step S120).

In FIG. 9, the intensity indicated by line L12 does not change greatly even when the mass-to-charge ratio of the setting target changes. That is, it is recognized that in the analysis with gas, the amount of the argon ion arriving at ion detector 17 does not change greatly even when the set value of the voltage applied to each electrode changes.

In contrast, although the intensity indicated by line L11 has a value close to the intensity indicated by line L12 when the mass-to-charge ratio of the setting target is 209, the intensity indicated by line L11 has a value that is approximately three orders of magnitude larger than the intensity indicated by line L12 in a region where the mass-to-charge ratio is equal to or less than 115. That is, it is recognized that when the mass-to-charge ratio of the ion to be detected is equal to or less than 115, the amount of the argon ion arriving at the downstream side of collision cell 11 is approximately three orders of magnitude larger in the analysis without gas than in the analysis with gas.

### Drift in Detection Result

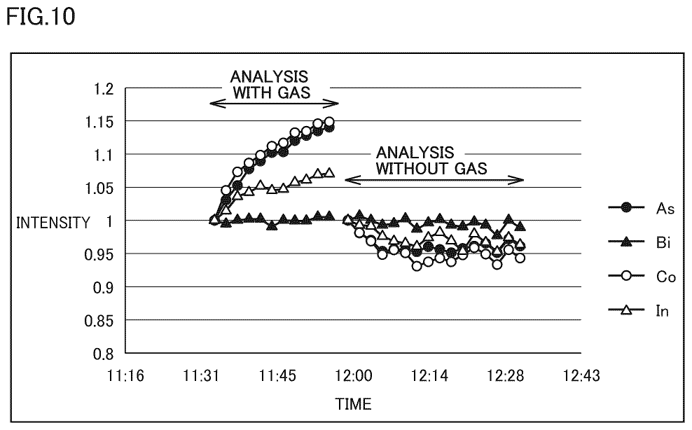

FIG. 10 shows detection results about ions to be analyzed in each of the analysis with gas and the analysis without gas. The detection results shown in FIG. 10 are treated as the comparative example.

FIG. 10 shows the results about each of four types of ions (As, Bi, Co, and In) to be analyzed, in each of the analysis with gas and the analysis without gas. The results in the analysis with gas shown in FIG. 10 are results in the analysis with gas performed immediately after the separately-performed analysis without gas. The results in the analysis without gas shown in FIG. 10 are results in the analysis without gas performed immediately after the analysis with gas shown in FIG. 10. The analysis with gas in FIG. 10 does not include the application of the adjustment voltage values (step S120).

In the analysis with gas shown in FIG. 10, when the ion to be detected is “Bi”, the detected intensity does not change greatly even when the time passes. However, when the ion to be detected is “In”, the detected intensity increases with the passage of time. Furthermore, when the ion to be detected is “As” and when the ion to be detected is “Co”, the detected intensity increases greatly with the passage of time and the detected intensity increases by approximately 15% from the start to the end of detection.

Similarly to the analysis with gas, in the analysis without gas shown in FIG. 10 as well, when the ion to be detected is “Bi”, the detected intensity does not change greatly even when the time passes. However, when the ion to be detected is “In”, a drift occurs in the detected intensity with the passage of time. Furthermore, when the ion to be detected is “As” and when the ion to be detected is “Co”, a drift occurs in the detected intensity with the passage of time and the detected intensity changes by approximately 15% at maximum with respect to the intensity at the start of detection.

### Improvement in Detection Result

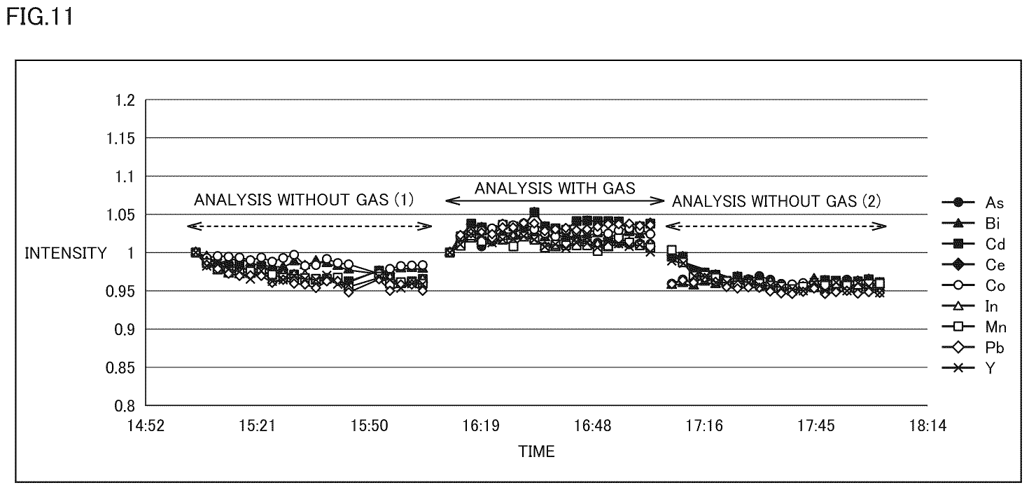

FIG. 11 shows detection results about ions to be analyzed in each of the analysis with gas and the analysis without gas. The detection results shown in FIG. 11 are according to the present embodiment.

FIG. 11 shows the results about each of nine types of ions (As, Bi, Cd, Ce, Co, In, Mn, Pb, and Y) to be analyzed, when the analysis without gas, the analysis with gas, and the analysis without gas are continuously performed. The first analysis without gas is denoted as “analysis without gas (1)”, and the second analysis without gas is denoted as “analysis without gas (2)”. That is, the analysis without gas (1), the analysis with gas, and the analysis without gas (2) are performed in this order. The analysis with gas in FIG. 11 includes the application of the adjustment voltage values (step S120).

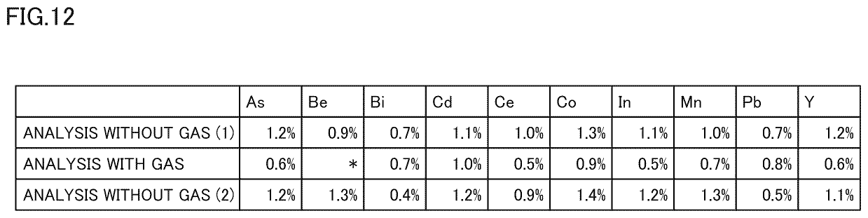

FIG. 12 shows maximum change rates at the start of detection about the detected intensities shown in FIG. 11. FIG. 12 also shows values about the ion (Be) whose data is not shown in FIG. 11. “*” described as the value about the Be ion in the analysis with gas means that ion detector 17 cannot detect the Be ion in the analysis with gas.

A maximum value of the rates shown in FIG. 12 is “1.4%” that is the result about the Co ion in the analysis without gas (2). That is, according to the present embodiment, even when the analysis with gas and the analysis without gas are repeated in mass spectrometer 100, the occurrence of a drift in the detected intensities of the ions with the passage of time from the start of detection is suppressed, as compared with the comparative example described with reference to FIGS. 9 to 11.

In the present embodiment, in the analysis with gas, mass spectrometer 100 applies the voltages having the adjustment voltage values to the respective electrodes before detection, thereby intentionally causing charge up. As a result, it is possible to suppress the occurrence of a drift in the detection results that is caused by the progress of charge up during detection of the ion to be detected in the analysis with gas. Furthermore, similarly to the analysis without gas, in the analysis with gas as well, the detection of the ion to be detected is performed in the presence of charge up, and thus, a difference in analysis conditions between the analysis with gas and the analysis without gas can be reduced.

### Utilization Period and Application of Voltage

In mass spectrometer 100, as a utilization period of mass spectrometer 100 becomes longer, charge up in quadrupole mass filter 16 (pre-rod electrode 16A and main rod electrode 16B) and the like becomes more likely to occur. Therefore, as the utilization period of mass spectrometer 100 becomes longer, the adjustment time period (step S122) may become shorter. In addition, as the utilization period of mass spectrometer 100 becomes longer, an absolute value of an adjustment voltage value may become smaller.

In one implementation, the utilization period of mass spectrometer 100 is written into the memory of controller 22. Adjustment voltage values for each electrode that correspond to two or more utilization periods are also stored in the memory. For example, an adjustment voltage value for each electrode when the utilization period is shorter than five years and an adjustment voltage value for each electrode when the utilization period is equal to or longer than five years are stored in the memory. As the utilization period becomes longer, the absolute values of the adjustment voltage values may become smaller.

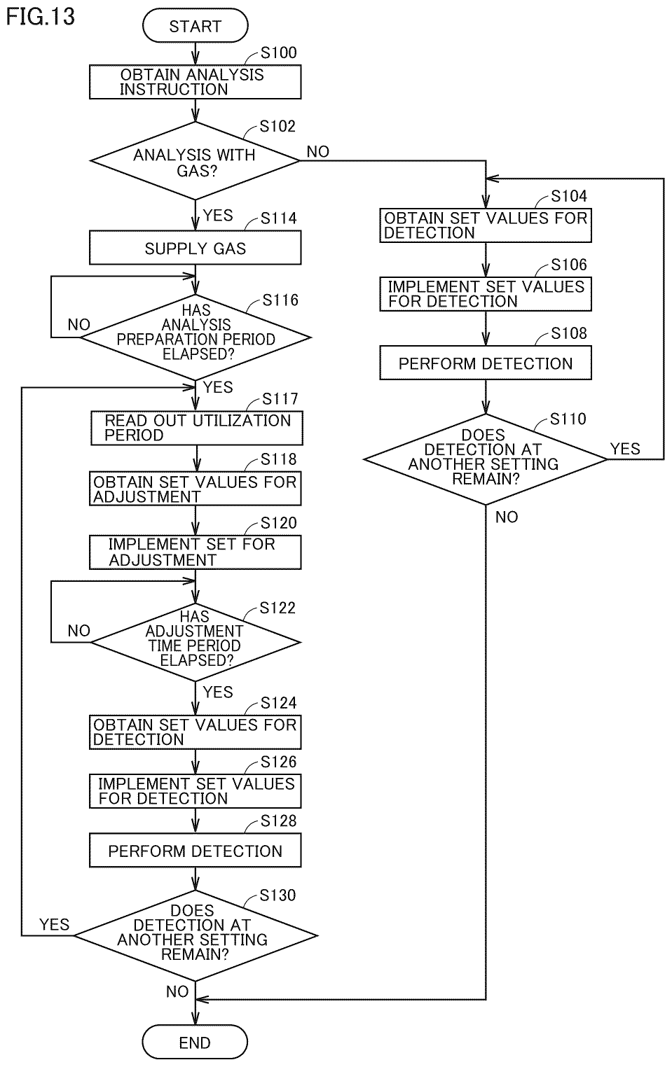

FIG. 13 is a flowchart according to a modification of the process shown in FIG. 6. The process shown in FIG. 13 is different from the process shown in FIG. 6 in that the process shown in FIG. 13 further includes step S117 after step S116.

When mass spectrometer 100 determines in step S116 that the analysis preparation period has elapsed, or when mass spectrometer 100 determines in step S130 that detection at another setting remains, mass spectrometer 100 advances the control to step S117.

In step S117, mass spectrometer 100 reads out the utilization period of mass spectrometer 100 from the memory of controller 22.

In step S118, mass spectrometer 100 reads out the adjustment voltage values corresponding to the utilization period read out in step S117.

In another implementation, “adjustment time period” corresponding to each of two or more utilization periods is stored in the memory. As the utilization period becomes longer, the adjustment time period may become shorter. In this case, in step S122, mass spectrometer 100 determines whether the adjustment time period corresponding to the utilization period read out in step S117 has elapsed. When mass spectrometer 100 determines in step S122 that the adjustment time period has elapsed, mass spectrometer 100 advances the control to step S124.

### ASPECTS

It will be understood by those skilled in the art that the plurality of exemplary embodiments described above are specific examples of the following aspects.

(Clause 1) A mass spectrometer according to an aspect includes: a plasma ion source that ionizes a sample by a plasma ion; a mass filter that allows a target ion having a specific mass-to-charge ratio, of the ionized sample, to selectively pass therethrough; a detector that detects the target ion; a collision cell provided between the plasma ion source and the mass filter; a gas supply unit that supplies a gas to the collision cell; and a controller that controls a value of a voltage applied to an electrode, wherein when the gas is supplied from the gas supply unit to the collision cell in detection of a first target ion, before detection of the first target ion, the controller applies a voltage having a first adjustment voltage value to an electrode located on a downstream side of the collision cell in an ion traveling direction, the first adjustment voltage value being obtained by adding an adjustment value to a first detection voltage value corresponding to the first target ion, and in detection of the first target ion, the controller applies a voltage having the first detection voltage value to the electrode located on the downstream side of the collision cell in the ion traveling direction, and the adjustment value may be a value indicating a polarity opposite to a polarity of the first target ion.

In the mass spectrometer according to clause 1, a difference in analysis conditions between when the gas is not introduced into the collision cell during analysis in the mass spectrometer and when the gas is introduced into the collision cell becomes smaller.

(Clause 2) In the mass spectrometer according to clause 1, the electrode located on the downstream side of the collision cell in the ion traveling direction may include a rod electrode of the mass filter.

In the mass spectrometer according to clause 2, a difference in analysis conditions regarding charge up in the rod electrode of the mass filter becomes smaller.

(Clause 3) The mass spectrometer according to clause 1 or 2 further includes an exit electrode provided between the collision cell and the mass filter, wherein the electrode located on the downstream side of the collision cell in the ion traveling direction may include the exit electrode.

In the mass spectrometer according to clause 3, a difference in analysis conditions regarding charge up in the exit electrode provided between the collision cell and the mass filter becomes smaller.

(Clause 4) The mass spectrometer according to any one of clauses 1 to 3 further includes an entrance electrode provided between the mass filter and the detector, wherein the electrode located on the downstream side of the collision cell in the ion traveling direction may include the entrance electrode.

In the mass spectrometer according to clause 4, a difference in analysis conditions regarding charge up in the entrance electrode provided between the mass filter and the detector becomes smaller.

(Clause 5) In the mass spectrometer according to any one of clauses 1 to 4, an ion optical axis in the mass filter is located at a different location in a given direction with respect to an ion optical axis in the collision cell, the mass spectrometer further includes a bending electrode provided between the collision cell and the mass filter to connect the ion optical axis in the collision cell and the ion optical axis in the mass filter in the given direction, and the electrode located on the downstream side of the collision cell in the ion traveling direction may include the bending electrode.

In the mass spectrometer according to clause 5, a difference in analysis conditions regarding charge up in the bending electrode becomes smaller.

(Clause 6) In the mass spectrometer according to any one of clauses 1 to 5, an absolute value of the adjustment value may become smaller as a utilization period of the mass spectrometer becomes longer.

In the mass spectrometer according to clause 6, a minimum voltage value required to reduce a difference in analysis conditions is set as the adjustment voltage value.

(Clause 7) In the mass spectrometer according to any one of clauses 1 to 6, a length of a time period in which the voltage having the first adjustment voltage value is applied to the rod electrode may become shorter as a utilization period of the mass spectrometer becomes longer.

In the mass spectrometer according to clause 7, the voltage having the adjustment voltage value is applied for a minimum time length required to reduce a difference in analysis conditions.

(Clause 8) In the mass spectrometer according to any one of clauses 1 to 7, the adjustment value may be common to a plurality of types of target ions.

In the mass spectrometer according to clause 8, it becomes easier to set the adjustment value.

(Clause 9) In the mass spectrometer according to any one of clauses 1 to 8, application of the voltage having the first adjustment voltage value may be started after supply of the gas to the collision cell is started.

In the mass spectrometer according to clause 9, the voltage having the adjustment voltage value is applied for a minimum necessary period.

(Clause 10) In the mass spectrometer according to any one of clauses 1 to 9, in the case where detection of a second target ion is performed after detection of the first target ion, the controller further applies the voltage having the first adjustment voltage value after detection of the first target ion and before detection of the second target ion, when the gas is supplied to the collision cell in detection of the second target ion.

In the mass spectrometer according to clause 10, charge up that occurs in analysis without gas can occur more reliably every time detection in analysis with gas is performed.

(Clause 11) In the mass spectrometer according to any one of clauses 1 to 9, in the case where detection of a second target ion is performed after detection of the first target ion, the controller may perform detection of the second target ion without applying the voltage having the first adjustment voltage value after detection of the first target ion, even when the gas is supplied to the collision cell in detection of the second target ion.

In the mass spectrometer according to clause 11, the voltage having the adjustment voltage value is applied to the minimum necessary.

(Clause 12) In a control method for a mass spectrometer according to an aspect, the mass spectrometer includes: a plasma ion source that ionizes a sample by a plasma ion; a mass filter that allows a target ion having a specific mass-to-charge ratio, of the ionized sample, to selectively pass therethrough; a detector that detects the target ion; and a collision cell provided between the plasma ion source and the mass filter. The control method includes: determining whether to supply a gas to the collision cell in detection of a first target ion; when it is determined to supply the gas to the collision cell in detection of the first target ion, before detection of the first target ion, applying a voltage having a first adjustment voltage value to an electrode located on a downstream side of the collision cell in an ion traveling direction in the mass spectrometer, the first adjustment voltage value being obtained by adding an adjustment value to a first detection voltage value corresponding to the first target ion; and in detection of the first target ion, applying a voltage having the first detection voltage value to the electrode, wherein the adjustment value may be a value indicating a polarity opposite to a polarity of the first target ion.

In the control method for the mass spectrometer according to clause 12, a difference in analysis conditions between when the gas is not introduced into the collision cell during analysis in the mass spectrometer and when the gas is introduced into the collision cell becomes smaller.

It should be understood that the embodiments disclosed herein are illustrative and non-restrictive in every respect. The scope of the present disclosure is defined by the terms of the claims, rather than the description of the embodiments above, and is intended to include any modifications within the scope and meaning equivalent to the terms of the claims. It is also contemplated that each technique in the embodiments can be implemented alone or in combination with other techniques in the embodiments as much as possible as necessary.

### REFERENCE SIGNS LIST

1 ionization chamber; 2 first vacuum chamber; 3 second vacuum chamber; 4 third vacuum chamber; 5 ion source; 6 sampling cone; 7 skimmer cone; 8 pull-in electrode; 10 ion lens; 10A front-side electrode; 10B rear-side electrode; 11 collision cell; 12, 19B, 20B entrance electrode; 13 exit electrode; 14 ion guide; 15 axis bending electrode; 16 mass filter; 16A pre-rod electrode; 16B main rod electrode; 17 ion detector; 18 ion optical axis; 19A axis bending exit electrode; 100 mass spectrometer.

1. A mass spectrometer comprising:
a plasma ion source that ionizes a sample by a plasma ion;
a mass filter that allows a target ion having a specific mass-to-charge ratio, of the ionized sample, to selectively pass therethrough;
a detector that detects the target ion;
a collision cell provided between the plasma ion source and the mass filter;
a gas supply unit that supplies a gas to the collision cell;
a setting unit that sets the presence or absence of gas supply by the gas supply unit;
one or more electrodes that form an electric field; and
a controller that controls a value of a voltage applied to an electrode, wherein
in response to supply of the gas from the gas supply unit to the collision cell in detection of a first target ion,
in preparation for detection of the first target ion, the controller applies a voltage having a first adjustment voltage value to an electrode located on a downstream side of the collision cell in an ion traveling direction, the first adjustment voltage value being obtained by adding an adjustment value to a first detection voltage value corresponding to the first target ion, and
in detection of the first target ion, the controller applies a voltage having the first detection voltage value to the electrode located on the downstream side of the collision cell in the ion traveling direction, and
the adjustment value is a value indicating a polarity opposite to a polarity of the first target ion.

2. The mass spectrometer according to claim 1, wherein
the electrode located on the downstream side of the collision cell in the ion traveling direction includes a rod electrode of the mass filter.

3. The mass spectrometer according to claim 1, further comprising
an exit electrode provided between the collision cell and the mass filter, wherein
the electrode located on the downstream side of the collision cell in the ion traveling direction includes the exit electrode.

4. The mass spectrometer according to claim 1, further comprising
an entrance electrode provided between the mass filter and the detector, wherein
the electrode located on the downstream side of the collision cell in the ion traveling direction includes the entrance electrode.

5. The mass spectrometer according to claim 1, wherein
an ion optical axis in the mass filter is located at a different location in a given direction with respect to an ion optical axis in the collision cell,
the mass spectrometer further comprises a bending electrode provided between the collision cell and the mass filter to connect the ion optical axis in the collision cell and the ion optical axis in the mass filter in the given direction, and
the electrode located on the downstream side of the collision cell in the ion traveling direction includes the bending electrode.

6. The mass spectrometer according to claim 1, wherein
an absolute value of the adjustment value becomes smaller as a utilization period of the mass spectrometer becomes longer.

7. The mass spectrometer according to claim 2, wherein
a length of a time period in which the voltage having the first adjustment voltage value is applied to the rod electrode becomes shorter as a utilization period of the mass spectrometer becomes longer.

8. The mass spectrometer according to claim 1, wherein
the adjustment value is common to a plurality of types of target ions.

9. The mass spectrometer according to claim 1, wherein
application of the voltage having the first adjustment voltage value is started after supply of the gas to the collision cell is started.

10. The mass spectrometer according to claim 1, wherein
in the case where detection of a second target ion is performed after detection of the first target ion, the controller further applies the voltage having the first adjustment voltage value after detection of the first target ion and before detection of the second target ion, when the gas is supplied to the collision cell in detection of the second target ion.

11. The mass spectrometer according to claim 1, wherein
in the case where detection of a second target ion is performed after detection of the first target ion, the controller performs detection of the second target ion without applying the voltage having the first adjustment voltage value after detection of the first target ion, even when the gas is supplied to the collision cell in detection of the second target ion.

12. A control method for a mass spectrometer,
the mass spectrometer including:
a plasma ion source that ionizes a sample by a plasma ion;
a mass filter that allows a target ion having a specific mass-to-charge ratio, of the ionized sample, to selectively pass therethrough;
a detector that detects the target ion; and
a collision cell provided between the plasma ion source and the mass filter,
the control method comprising:
determining whether to supply a gas to the collision cell in detection of a first target ion;
when it is determined to supply the gas to the collision cell in detection of the first target ion, in preparation for detection of the first target ion, applying a voltage having a first adjustment voltage value to an electrode located on a downstream side of the collision cell in an ion traveling direction in the mass spectrometer, the first adjustment voltage value being obtained by adding an adjustment value to a first detection voltage value corresponding to the first target ion; and
in detection of the first target ion, applying a voltage having the first detection voltage value to the electrode, wherein
the adjustment value is a value indicating a polarity opposite to a polarity of the first target ion.
